(19) United States
(12) Patent Application Publication
(10) Pub. No.: US 2006/0290744 A1
(43) Pub. Date: Dec. 28, 2006

(54) Wire bonding structure to electrically connect a printhead chip to a flexible printed circuit of an ink cartridge and method thereof

(76) Inventors: Jao-cheol Lee, Hwaseong-si (KR); Jung-wook Kim, Yongin-si (KR); Seo-hyun Cho, Seongnam-si (KR)

Correspondence Address: STANZIONE & KIM, LLP, 919 18TH STREET, N.W., SUITE 440, WASHINGTON, DC, 20006, US

(21) Appl. No.: 11/334,553

(22) Filed: Jan. 19, 2006

(30) Foreign Application Priority Data
Jun. 25, 2005 (KR) 2005-55417

(51) Int. Cl. B41J 2/05

(52) U.S. Cl. 347/58

(57) ABSTRACT

A wire bonding structure that electrically connects a printhead chip with a flexible printed circuit (FPC) using a wire includes a ball formed on a bonding pad provided on a surface of the printhead chip, a wire having a first end connected to the ball and a second end bonded to the FPC, the first end of the wire connected to the ball has a bent portion in which a first portion of the wire is bent over a surface of the bonding pad to overlap a second portion of the wire located over the surface of the bonding pad.

### CROSS-REFERENCE TO RELATED APPLICATIONS

This application claims the benefit of Korean Patent Application No. 2005-55417, filed on Jun. 25, 2005, in the Korean Intellectual Property Office, the disclosure of which is incorporated herein in its entirety by reference.

### BACKGROUND OF THE INVENTION

1. Field of the Invention

The present general inventive concept relates to an ink cartridge of an inkjet printer, and more particularly, to a wire bonding structure to electrically connect a printhead chip that ejects ink to a flexible printed circuit (FPC), and a method thereof.

2. Description of the Related Art

Generally, an inkjet printer is an apparatus that ejects micro droplets of print ink to a desired position on a printing medium such as a paper sheet, fabric and so forth, to print an image in a certain color on a surface of the printing medium.

Inkjet printers include an ink cartridge for ejecting ink droplets onto the printing medium, i.e., the paper sheet. The ink cartridge includes an ink tank storing printing ink, a printhead chip ejecting ink droplets through a plurality of nozzles, an ink channel unit supplying ink from the ink tank to the printhead chip, and a flexible printed circuit (FPC) applying an electrical signal to the printhead chip.

FIG. 1 is a sectional view of a portion of a conventional ink cartridge in which the printhead chip and the FPC are electrically connected with each other via wire bonding.

Referring to FIG. 1, the printhead chip 20 is mounted to a frame 10 of the ink cartridge. The ink tank (not shown) and the ink channel unit (not shown) are also mounted to the frame 10, and the FPC 30 is attached thereto to apply an electrical signal to the printhead chip 20. A plurality of bonding pads 22 are arranged on the surface of the printhead chip 20, and the FPC 30 has a plurality of leads 32 corresponding to the bonding pads 22, respectively, and an insulating film 34 to support and insulate the leads 32. The bonding pads 22 of the printhead chip 20 and the leads 32 of the FPC 30 are electrically connected to each other using a plurality of wires 40. Each of the wires 40 is covered with an insulating material to provide insulation and protection, which is referred to as an encap 50.

FIG. 2 is a view illustrating a wire bonding method of the prior art, and FIG. 3 is a view illustrating a problem caused from the wire bonding method of FIG. 2.

Referring first to FIG. 2, the wire bonding is generally performed, for example, by the movement of a capillary 60 along a certain path. More particularly, one end of the wire 40 is fused using the capillary 60 to form a ball 42 on the surface of the bonding pad 22 of the printhead chip 20. Then, the capillary 60 is moved towards the surface of the lead 32 of the FPC 30 along a path defined by arrows A, B and C. As illustrated in FIG. 3, the wire 40 is thus formed in a shape of a loop having a certain height H₁. Next, the other end of the wire 40 is wedge-bonded onto the surface of the lead 32 of the FPC 30 using the capillary 60.

However, according to the above wire bonding method of FIG. 2, a problem is often caused in that a neck portion of the wire 40 connecting the ball 42 and the wire 40 breaks apart. This problem occurs because impurities tend to be collected at an interface between the ball 42 and the wire 40, and a tensile stress generated when the capillary 60 is moved becomes concentrated on the interface between the ball 42 and the wire 40.

Further, according to the above wire bonding method of FIG. 3, there is a drawback in that the loop height H₂ of the wire 40 is relatively high, and thus a height H₂ of the encap 50 must also be high to insulate and protect the wire 40. In the wire bonding method of FIG. 3, the loop height H₁ of the wire 40 is approximately 150 to 200 μm, and the height H₁ of the encap 50 is approximately 200 to 300 μm. In the event that the height H₂ of the encap 50 is 200 to 300 μm in height, a problem occurs when the surface of the printhead chip 20 is wiped with a wiping blade 70. That is, a no wiping margin W used to protect the printhead chip 20 is enlarged when the height H₂ of the encap 50 becomes high. For example, when the height H₂ of the encap 50 is 250 μm, the no wiping margin W is approximately 625 μm or 2.5 times the height H₂ of the encap 50. The no wiping margin W indicates a width of a portion where the wiping blade 70 is not in contact with the surface of the printhead chip 20, so that there are problems in that as the no wiping margin W is wide, the surface of the printhead chip 20 is likely to be contaminated with ink or foreign substances. Accordingly, a size of the printhead chip 20 must be increased to accommodate the size of the no wiping margin W.

To solve the above problems of the prior wire bonding method of FIG. 3, a following tab bonding method is used.

FIG. 4 is a view illustrating a tab bonding method of the prior art.

Referring to FIG. 4, a flexible printed circuit (FPC) 30′ is used which has a flying lead 32′ separated from an insulating film 34′. More particularly, a stud bump 80 is formed on the bonding pad 22 of the printhead chip 20 and the flying lead 32′ is placed on the stud bump 80. Then, using a tab tool 90 of an ultrasonic vibrator, the flying lead 32′ is pressed and bonded to the surface of the stud bump 80 using vibrations and supersonic waves.

According to this tab bonding method illustrated in FIG. 4, there are advantages in that the height of the encap is lowered and damage to the neck portion of the flying lead 32′ between the stud bump 80 and the FPC 30′ can be avoided, as compared with the prior wire bonding method of FIG. 3. However, in the tab bonding method, after the formation of the stud bump 80, the protrusions on the upper surface thereof should be removed for leveling, and thus a stud bump machine and a leveler are required to perform these operations of the tab bonding method. In addition, an ultrasonic vibrator is also required to bond the flying lead 32′ onto the stud bump 80. Therefore, the tab bonding method has a drawback in that costs are high and productivity is lowered because a complex process and various equipment is required.

Further, in the tab bonding method, there may be problems with using the flying lead 32′, which is separated from the insulating film 34′, for example, a manufacturing process thereof is complicated and lower quality products may be produced, and the flying lead 32′ is not supported by the insulating film 34′ so that the flying lead sags under weight.

### SUMMARY OF THE INVENTION

The present general inventive concept provides a wire bonding structure to electrically connect a printhead chip to a flexible printed circuit (FPC) of an ink cartridge, capable of lowering a height of an encap and reducing the risk of damage at a neck portion of a wire located between a ball and the wire, and a method thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a wire bonding structure that electrically connects a printhead chip with a flexible printed circuit (FPC) using a wire, the structure including, a ball formed on a bonding pad provided on a surface of the printhead chip, and a wire having a first end connected to the ball and a second end bonded to the FPC, the first end of the wire connected to the ball has a bent portion in which a first portion of the wire is bent over a surface of the bonding pad to overlap a second portion of the wire located over the surface of the bonding pad.

The wire may extend from the bending portion toward the FPC and may be substantially parallel to the surface of the printhead chip.

The ball may be formed on the surface of the bonding pad and the second end of the wire may be bonded to the surface of a lead of the FPC.

The wire bonding structure may further include an encap covering the wire to insulate and protect the wire. A loop height of the wire from the surface of the printhead chip may be approximately 70 μn or less, and the height of the encap from the surface of the printhead chip may be approximately 150 μm or less.

The foregoing and/or other aspects of the present general inventive concept may also be achieved by providing a wire bonding method of electrically connecting a printhead chip with a flexible printed circuit (FPC), the method including forming a ball on a bonding pad provided on a surface of the printhead chip , connecting a first end of a wire to the ball such that a first portion of the wire is bent over a surface of the bonding pad to overlap a second portion of the wire located over the surface of the bonding pad, and bonding a second end of the wire to the lead.

The wire bonding method may further include forming an encap covering the wire to insulate and protect the wire.

The ball may be formed on the surface of the bonding pad and the second end of the wire may be bonded to a surface of a lead of the FPC.

The ball may be formed by fusing the first end of the wire using a wire bonding device.

The bent portion of the wire may be formed by moving the wire bonding device in at least four directions.

In The operation of forming the bending portion may include lifting the wire bonding device a first distance in a direction orthogonal to the surface of the printhead chip, moving the wire bonding device a second distance parallel to the surface of the printhead chip in a direction opposite to the FPC, to bend a portion of the wire in a horizontal direction with respect to the surface of the printhead chip, lifting the wire bonding device a third distance in a direction orthogonal to the surface of the printhead chip to bend the horizontally bent portion of the wire in a direction perpendicular to the surface of the printhead chip, and moving the wire bonding device a fourth distance parallel to the surface of the printhead chip in a direction toward the FPC to create a bent portion in the wire that bends in a horizontal direction with respect to the surface of the printhead chip.

The wire bonding method may further include lowering the wire bonding device a fifth distance towards the surface of the print head chip, and pressing the wire in a direction orthogonal to the surface of the printhead chip while lowering the wire bonding device the fifth distance.

The foregoing and/or other aspects of the present general inventive concept may also be achieved by providing a wire bonding structure that electrically connects a printhead chip with a flexible printed circuit (FPC) using a wire, the structure including a ball formed on at least one of a bonding pad provided on a surface of the printhead chip and a lead provided on a surface of the FPC, and a wire having a first end connected to the ball and a second end bonded to the other one of the at least one of the bonding pad and the lead, and having a first portion which is bent over a surface of at least one of the bonding pad and the lead to overlap with a second portion of the wire located over the same surface as the first portion of the wire.

The foregoing and/or other aspects of the present general inventive concept may also be achieved by providing a wire bonding method of electrically connecting a printhead chip with a flexible printed circuit (FPC) using a wire, the method including forming a ball on at least one of a bonding pad of the printhead chip and a lead of the FPC, connecting a first end of a wire to the ball such that a first portion of the wire is bent over a surface of the ball to overlap a second portion of the wire located over the surface of the ball, and bonding a second end of the wire to at least one of the bonding pad and the lead of which does not have the ball formed thereon.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a sectional view of a portion of a conventional ink cartridge, illustrating a state that a printhead chip and a wire are electrically connected each other by a wire bonding;

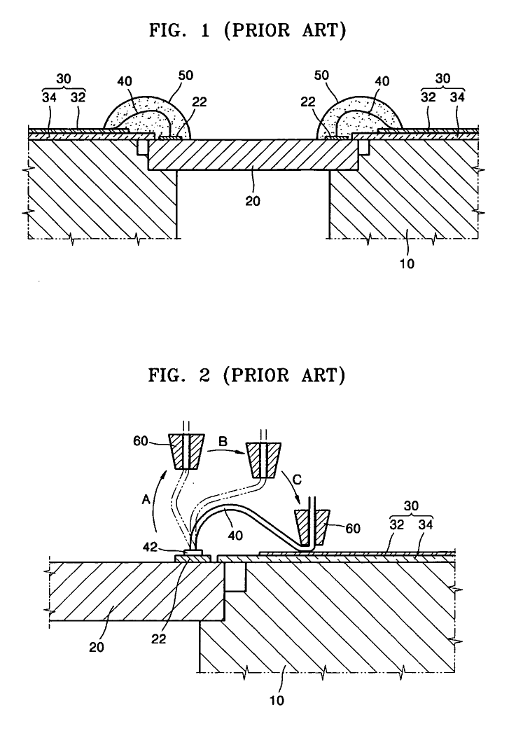

FIG. 2 is a view illustrating a conventional wire bonding method;

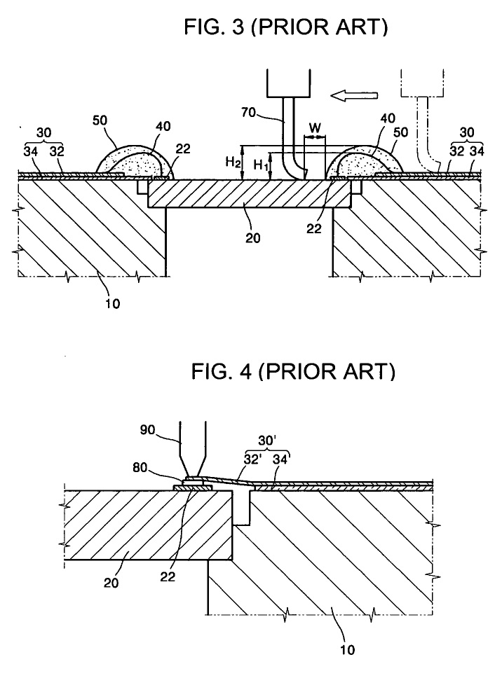

FIG. 3 is a view illustrating a problem generated from a conventional wire bonding method;

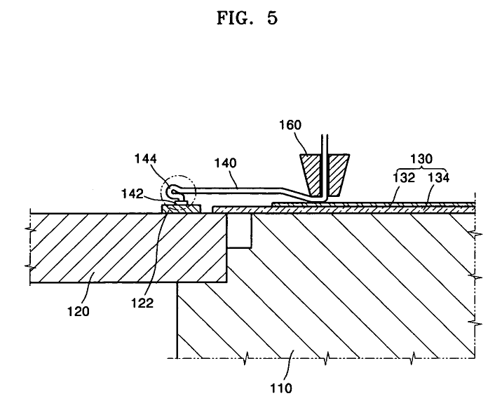

FIG. 4 is a view illustrating a conventional tab bonding method;

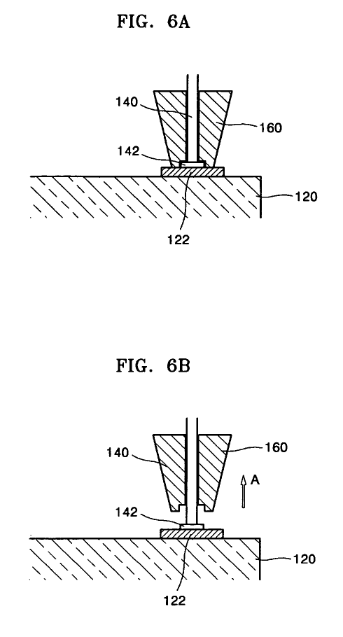

FIG. 5 is a view illustrating a wire bonding structure according to an embodiment of the present general inventive concept;

FIGS. 6A through 6F are views illustrating a method of forming a bending portion at one end of the wire illustrated in FIG. 5; and

FIG. 7 is a view illustrating a wire bonding structure according to the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

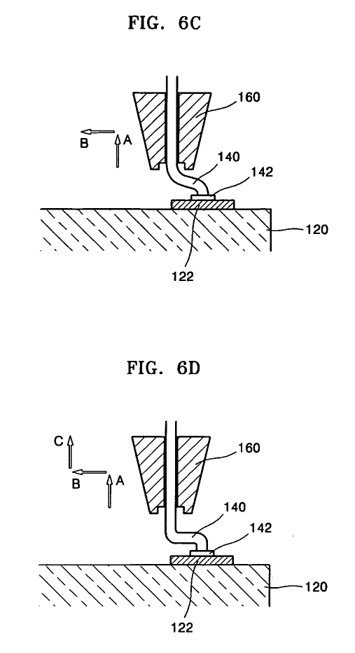

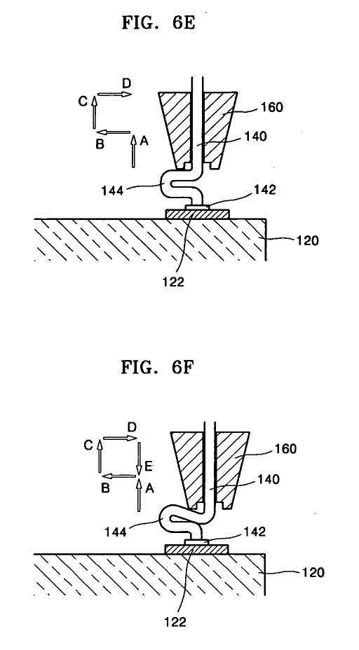

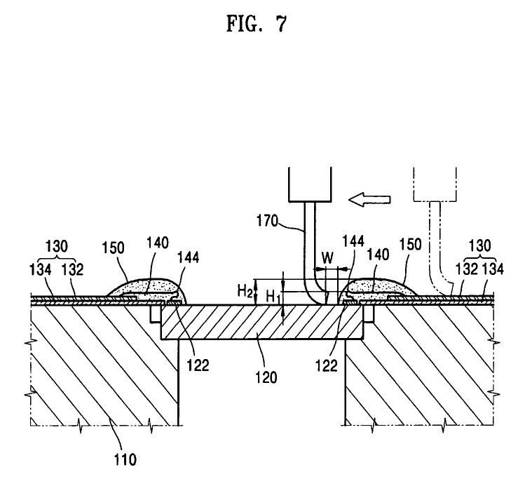

FIG. 5 is a view illustrating a wire bonding structure according to an embodiment of the present general inventive concept, and FIGS. 6A through 6F are views illustrating a method of forming a bending portion at one end of the wire illustrated in FIG. 5. FIG. 7 illustrates both sides of the printhead chip 120.

Referring to FIGS. 5 and 7, a printhead chip 120 is mounted to a frame 110 of an ink cartridge to discharge ink droplets through a plurality of nozzles (not shown). Also, a flexible printed circuit (FPC) 130 is attached to the frame 110 to apply an electric signal to the printhead chip 120. A plurality of bonding pads 122 are arranged on the surface of the printhead chip 120. The FPC 130 includes a plurality of leads 132 corresponding to the bonding pads 122, respectively, and an insulating film 134 to insulate and support the leads 132. The bonding pads 122 of the printhead chip 120 and the leads 132 of the FPC 130 are electrically connected together using a wire 140.

The wire 140 may be made from a metal, for example, gold, which has a good elongation percentage and electrical conductivity to facilitate a wire with a small diameter. One end of the wire 140 is bonded to the bonding pad 122 of the printhead chip 120, and the other end is bonded to the lead 132 of the FPC 130. The wire bonding can be performed by the movement of a wire bonding device, for example, a capillary 160, via a certain path.

In the present embodiment, a ball 142 is formed on the surface of the bonding pad 122, and a bending portion 144 is formed at one end of the wire 140 that is connected to the ball 142. That is, the bending portion 144 is formed at a neck portion of the wire 140 between the ball 142 and the wire 140. The bending portion 144 has an overlapping shape that causes a first portion of the wire 140 that is bent over the ball 142 to overlap with a second portion of the wire 140, which may also be bent over the ball 142. Further, the wire 140 extends from the bending portion 144 towards the lead 132 substantially parallel to the surface of the printhead chip 120, i.e., in a horizontal direction, so that the other end of the wire 140 is bonded to the surface of the lead 132. As a result, the wire bonding is established between the bonding pads 122 of the printhead chip 120 and the leads 132 of the FPC 130, as illustrated in FIG. 7.

Alternatively, the ball 142 and the bending portion 144 formed at one end of the wire 140 may instead be formed on the surface of the lead 132 of the FPC 130. In this case, the other end of the wire 140 is bonded to the surface of the bonding pad 122 of the printhead chip 120.

As described above, when the bending portion 144 is formed at one end of the wire 140, the neck portion between the ball 142 and the wire 140 is strengthened so that wire damage or breakage at the neck portion can be prevented is less likely to occur. In addition, the loop height of the wire 140 is lowered so that a no wiping margin W is narrowed.

Hereinafter, a method of forming the bending portion 144 at one end of the wire 140, as illustrated in FIG. 5, will be described with reference to FIGS. 6A through 6F.

Referring first to FIG. 6A, one end of the wire 140 is fused using the capillary 160, which forms the ball 142 on the surface of the bonding pad 122 of the printhead chip 120.

Then, as illustrated in FIG. 6B, the capillary 160 is lifted to a certain height or first distance in a direction orthogonal to the surface of the printhead chip 120, i.e., in a perpendicular direction, along an arrow path A.

Next, as illustrated in FIG. 6C, the capillary 160 is moved a second distance in a direction parallel to the surface of the printhead chip 120, i.e., in a horizontal direction, along an arrow path B. In this example, the capillary 160 is moved in a direction opposite to a location of the lead 132 of the FPC 130. Therefore, a portion of the wire 140 is substantially bent in a horizontal direction.

Then, as illustrated in FIG. 6D, the capillary 160 is lifted to a certain height or a third distance in a direction perpendicular to the surface of the printhead chip 120, along an arrow path C, and then the wire 140 is bent in a direction perpendicular to the horizontally bent portion.

Next, as illustrated in FIG. 6E, the capillary 160 is moved a fourth distance in a horizontal direction with respect to the surface of the printhead chip 120 along an arrow path D and then moved toward the lead 132 of the FPC 130. Then, the wire 140 is bent in a horizontal direction of the surface of the printhead chip 120 to form the bent portion 144.

Next, as illustrated in FIG. 6F, the capillary 160 presses the wire 140 while being lowered a certain height of a fifth distance in a direction perpendicular to the surface of the printhead chip 120 along an arrow path E.

Finally, the bending portion 144 is formed at the one end of the wire 140, in which the first portion of the wire 140 is bent over the surface area of the ball 142 to overlap with a second portion of the wire 140.

When the bending portion 144 is formed at the neck portion between the ball 142 and the wire 140, a tensile stress phenomenon generated when the capillary 160 moves, and which is concentrated at the neck portion between the ball 142 and the wire 140, is eliminated is reduced, so that the likelihood that damage or breakage of the neck portion occurs can be prevented reduced.

After the formation process of the bending portion 144, as illustrated in FIGS. 6A through 6F, the capillary 160 is moved horizontally toward the lead 132, and the other end of the wire 140 is then wedge-bonded to the surface of the lead 132, as illustrated in FIG. 5.

FIG. 7 is a view illustrating the wire bonding structure according to the present general inventive concept.

Referring to FIG. 7, the wire 140 is bonded between the bonding pad 122 of the printhead chip 120 and the lead 132 of the FPC 130, and an encap 150 is formed to cover the wire 140. The encap 150 may be made from insulating synthetic resin, for example, epoxy resin.

According to the embodiment of FIG. 7, the loop height H₁ of the wire 140 may be lowered to approximately 70 μm or less, i.e., to approximately 60 μm. Thus, the height H₂ of the encap 150 may also be lowered to approximately 150 μm or less, i.e., to approximately 100 μm. Accordingly, if the height H₂ of the encap 150 is considerably low, a wiping blade 170 used to wipe the surface of the printhead chip 120, will have a no wiping margin W that is also considerably low. For example, when the height H₂ of the encap 150 is 100 μm, the no wiping margin W becomes approximately 250 μm or 2.5 times the height H₂ of the encap 150. Accordingly, if the no wiping margin W is narrowed, the surface of the printhead chip 120 can be wiped more efficiently, and the size of the printhead chip 120 can be reduced.

As described before, according to the present general inventive concept, the loop height H₁ of the wire 140 is lowered so that the height of the encap H₂ may be lowered. Accordingly, the no wiping margin W is narrowed so that the surface of the printhead chip is wiped more efficiently, and the size of the printhead chip may also be reduced.

In addition, the neck portion of the wire 140 between the ball 142 and the wire 140 is strengthened so that the likelihood of damage occurring to the neck portion is advantageously prevented.

Further, the wire bonding method of the present general inventive concept does not require a stud bump procedure, thus no complicated process or various equipment is necessary when performing the stud bump procedure.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A wire bonding structure that electrically connects a printhead chip with a flexible printed circuit (FPC) using a wire, the structure comprising:
a ball formed on a bonding pad surface provided on the printhead chip; and
a wire having a first end connected to the ball and a second end bonded to the FPC, the first end of the wire connected to the ball has a bent portion in which a first portion of the wire is bent over a surface of the bonding pad to overlap a second portion of the wire located over the surface of the bonding pad.

2. The wire bonding structure according to claim 1, wherein the wire extends from the bending portion toward the FPC, and is substantially parallel to the surface of the printhead chip.

3. The wire bonding structure according to claim 1, wherein the ball is formed on the surface of the bonding pad and the second end of the wire is bonded to the surface of a lead of the FPC.

4. The wire bonding structure according to claim 1, further comprising:
an encap covering the wire to insulate and protect the wire.

5. The wire bonding structure according to claim 4, wherein a loop height of the wire from the surface of the printhead chip is approximately 70 μm or less, and the height of the encap from the surface of the printhead chip is approximately 150 μm or less.

6. A wire bonding method of electrically connecting a printhead chip with a flexible printed circuit (FPC) using a wire, the method comprising:
forming a ball on a bonding pad surface provided on the printhead chip;
connecting a first end of a wire to the ball such that a first portion of the wire is bent over a surface of the bonding pad to overlap a second portion of the wire located over the surface of the bonding pad; and
bonding a second end of the wire to the FPC.

7. The wire bonding method according to claim 6, further comprising:
forming an encap covering the wire to insulate and protect the wire.

8. The wire bonding method according to claim 6, wherein the ball is formed on the surface of the bonding pad and the second end of the wire is bonded to a surface of a lead of the FPC.

9. The wire bonding method according to claim 6, wherein the ball is formed by fusing the first end of the wire using a wire bonding device.

10. The wire bonding method according to claim 6, wherein the bent portion of the wire is formed by moving a wire bonding device in at least four directions.

11. The wire bonding method according to claim 10, wherein the operation of forming the bent portion of the wire comprises:
lifting the wire bonding device a first distance in a direction orthogonal to the surface of the printhead chip;
moving the wire bonding device a second distance parallel to the surface of the printhead chip in a direction opposite to the FPC, to bend a portion of the wire in a horizontal direction with respect to the surface of the printhead chip;
lifting the wire bonding device a third distance in a direction orthogonal to the surface of the printhead chip to bend the horizontally bent portion of the wire in a direction perpendicular to the surface of the printhead chip; and
moving the wire bonding device a fourth distance parallel to the surface of the printhead chip in a direction toward the FPC, to create a bent portion in the wire that bends in a horizontal direction with respect to the surface of the printhead chip.

12. The wire bonding method according to claim 11, further comprising:
lowering the wire bonding device a fifth distance towards the surface of the print head chip; and
pressing the wire in a direction orthogonal to the surface of the printhead chip while lowering the wire bonding device the fifth distance.

13. The wire bonding method according to claim 10, wherein the wire bonding device is a capillary.

14. The wire bonding method according to claim 6, wherein the wire extends from the bending portion toward the FPC, and is substantially parallel to the surface of the printhead chip.

15. The wire bonding method according to claim 6, wherein a loop height of the wire from the surface of the printhead surface is approximately 70 μm or less, and the height of the encap from the surface of the printhead is approximately 150 μm or less.

16. A wire bonding structure that electrically connects a printhead chip with a flexible printed circuit (FPC) using a wire, the structure comprising:
a ball formed on at least one of a bonding pad provided on a surface of the printhead chip and a lead provided on a surface of the FPC; and
a wire having a first end connected to the ball and a second end bonded to the other one of the at least one of the bonding pad and the lead, and having a first portion which is bent over a surface of at least one of the bonding pad and the lead to overlap with a second portion of the wire located over the same surface as the first portion of the wire.

17. The wire bonding structure according to claim 16, wherein the bent portion of the wire begins at a neck portion of the wire located at an area where the ball meets the wire.

18. The wire bonding structure according to claim 16, wherein the wire is substantially parallel to the surface of the printhead chip and the surface of the FPC.

19. The wire bonding structure according to claim 16, wherein the bent portion of the wire forms a loop shape such that a portion of the loop has a height greater than a height of the remaining portion of the wire that extends beyond the bent portion of the wire.

20. The wire bonding structure according to claim 16, wherein the bent portion of the wire forms a loop shape such that a first portion of the loop has a greater cross sectional area than a second portion of the loop.

21. A wire bonding method of electrically connecting a printhead chip with a flexible printed circuit (FPC) using a wire, the method comprising:
forming a ball on at least one of a bonding pad of the printhead chip and a lead of the FPC;
connecting a first end of a wire to the ball such that a first portion of the wire is bent over a surface of the ball to overlap a second portion of the wire located over the surface of the ball; and
bonding a second end of the wire to the other one of the at least one of the bonding pad and the lead of the FPC.
